(19) United States
(12) Patent Application Publication
(10) Pub. No.: US 2003/0196864 A1
(43) Pub. Date: Oct. 23, 2003

(54) OIL BATH DISC CLUTCH STRUCTURE

(76) Inventor: Michael J. Brooks, Bluff City, TN (US)

Correspondence Address: Michael J. Brooks, 295 Lewis Rd., Bluff City, TN, 37618, US

(21) Appl. No.: 10/127,247

(22) Filed: Apr. 22, 2002

(51) Int. Cl. F16D 13/72

(52) U.S. Cl. 192/70.12; 192/70.23; 192/105 C; 192/113.36

(57) ABSTRACT

An oil bath disc clutch structure having a series of floater discs having an annular contact face on each of its sides, and friction discs arranged axially alternately with said floater discs around an axis of rotation within a housing having an exteriorly mounted power transmission element, wherein the floater discs are rotated around the axis by a motor shaft, wherein the friction discs are axially slidably keyed to the housing and are provided on each side with a friction material contact face, wherein the contact faces of the floater and friction discs are brought into locking engagement by a centrifugal acting pressure mechanism in order to rotate the housing and element, and wherein large volume oil discharge slots are provided generally radially in the friction material for assisting in the rapid discharge of oil from between the contact faces of adjacent discs during the clutch engagement process brought on by engine acceleration.

### BACKGROUND OF THE INVENTION

This invention concerns improvements in oil bath disc clutch construction, particularly the clutches used on chain driven go-carts, mini racing carts or the like as described in detail in U.S. Pat. No. 4,111,291, particularly in the exploded view of FIG. 9 thereof, the entire disclosure of which patent however, is hereby incorporated herein by reference. In the operation of such clutches, multiple releases and re-engagements of the high temperature accommodating friction discs from and with the floater discs thru engine deceleration and acceleration take place within a clutch disc gallery partially filled with oil. in such clutches, each friction disc often comprises a supporting metal disc having angularly spaced friction segments, e.g., 40 or so of friction lining material such as automobile clutch lining. These segments have previously been formed by slotting the lining on each side of the friction disc to a depth of about 0.01 in. and a width of about 0.05 in. These slots which act as oil discharge passages extend completely across the annular contact faces of the disc, typically about 0.4 in.

It is noted that with such clutches wherein the motor shaft and floater discs are rotating at near clutch engagement speed, the clutch oil is centrifugally slung radially outwardly in the housing to a depth of, e.g., ⅜″ to ½″ to completely immerse the friction segments. In such an environment even at low engine rpm all discs are normally loaded up with oil thru rotation of the floater discs thru the oil sump. Then, as the engine sped is increased and centrifugal forces rotate the cam weights to act on the pressure plate to force the friction and floater discs into engagement, the oil is trapped between the discs and acts as a hydraulic cushion. Even though the cushion dissipates quickly and allows the disc surfaces to forcefully engage each other, the time period required for the dissipation results in variations of, for example, 25%-30% in the engine speed needed to fully engage the clutch. These variations are quite nettlesome to the driver whose performance relies on immediate and anticipated response to his operation of the accelerator. In this regard, hot clutches often throw hot oil out on the driver or can ignite, creating a dangerous situation.

Additionally, during this time period when the excess oil is being forced out from between the discs, portions of the discs slide on each other and, of course, generate frictional heat, e.g., up to about 280° F. or more. Such heat deteriorates the lining composition of the friction discs and also warps or cracks the floater discs and drastically shortens the clutch life, often before a race is completed.

A principal object therefore, of the present invention is to provide an oil bath disc clutch structure which has markedly improved response to engine acceleration and greatly increased longevity.

### SUMMARY OF THE INVENTION

The above and other objects hereinafter becoming evident have been attained in accordance with the present invention which, in a preferred broad embodiment is defined as an oil bath disc clutch structure comprising a series of floater discs hawing an annular contact face on each of its sides, and friction discs arranged axially, alternately around an axis of rotation within a housing, wherein the floater discs are rotated around said axis by a motor shaft, wherein said friction discs are axially slidably keyed to the housing and are provided on each side with a friction material contact face, wherein said contact faces of said floater and friction discs are brought into locking engagement by centrifugal acting pressure means in order to rotate said housing, and wherein large volume oil discharge slots are provided generally radially in said friction material for assisting in the rapid discharge of oil from between the contact faces of adjacent discs during the clutch engagement process brought on by engine acceleration.

In summary, the present invention comprises markedly increasing the volumetric capacity of the aforesaid oil discharge slots in the friction discs to carry oil away more quickly from the contact faces thereof and of the floater discs. A further aspect of the invention comprises providing pressure relief or pressure equalizing oil ports thru the faces of the floater discs such that as the contact faces of the floater discs rapidly slide on the aforesaid segments just prior to locking up of the clutch, the slots of the friction discs adjacent each side of each floater disc will experience uniform pressure and insure simultaneous lock up of all discs. This phenomenon will farther diminish the generation of frictional heat and warpage of the floater discs and will markedly increase longevity of the friction segments. A further aspect of the invention comprises providing additional oil drain ports thru the backing plate where the plate is provided with bearing protuberances extending proximally from the plate surface of some backing plates, a more detailed explanation of which is given below.

### BRIEF DESCRIPTION OF THE DRAWINGS

The invention will be farther understood from the following description and drawings where certain structures are shown enlarged for clarity and structural proportions vary from figure to figure, and wherein:

FIG. 1 is a generally axial cross-sectional view of the present clutch in a disengaged condition, taken along the line 1-1 in FIG. 2, with a portion of the motor shaft mounted therein and with portions of the cam weight support broken away and portions thereof shown in relief for clarity;

FIG. 2 is a view of the cam weight support body taken along line 2-2 of FIG. 1 in the direction of the arrows and showing only one cam recess and one set of eight sets of identical cam weights, the location of the other recesses shown by broken lines;

FIG. 3 is a cross-sectional views of the cam weight support taken along line 3-3 of FIG. 2 in the direction of the arrows;

FIG. 4 is a cross-sectional view as partially as shown in FIG. 2 showing a cam weight in a partially rotated (clockwise) position exerting axial force against the pressure plate which face has moved the plate axially away from the cam weight support,

FIG. 5 is a side view of the one embodiment of the present friction disc and showing a section of the sprocket drum axially slidably keying with the disc key nodes of the friction disc;

FIG. 6 is a cross sectional view taken along line 6-6 of FIG. 5 in the direction of the arrows;

FIG. 7 is a side view of another embodiment of the present friction discs with only a few of the segments shown;

FIG. 8 is a side view of one of the present floater discs showing its key fingers axially slidably engaged with the key splines of the drive gear;

FIG. 9 is a view of the pressure plate taken along line 9-9 of FIG. 1 in the direction of the arrows, as axially slidably mounted on the drive gear key splines or teeth, and with the cam means shown only in broken line outline;

FIG. 10 is an enlarged side view, partially in cross-section, of the drive hub means as a monolithic machined unit;

FIG. 11 is an enlarged edge view of the friction disc taken along line 11-11 of FIG. 5 in the direction of the arrows and showing friction segments on one side of the metal support disc for the purpose of calculating the present contact surface areas of the friction faces and the volumes of the oil discharge slots and showing a portion of a floater disc keyed thereto;

FIG. 12 is a reduced size view of the sprocket drum portion of the housing also taken along line 9-9 in FIG. 1 in the direction of the arrows;

FIG. 13 is a contact face view of the backing plate;

FIG. 14 is a cross-sectional view taken along line 14-14 of FIG. 13;

FIG. 15 is an exterior end view, of the sprocket drum taken in the direction of line 15-15 in FIG. 1 and showing a portion of a friction disc in dotted line and keyed to the drum;

FIG. 16 is an exterior end view of the oil cover taken in the direction of line 16-16 in FIG. 1;

FIG. 17 is an enlarged cross-sectional view of the pressure plate motion resistance mechanism; and

FIG. 18 is an enlarged view of an indentation of FIG. 13.

### DETAILED DESCRIPTION OF THE DRAWINGS

Referring to the drawings and with particular reference to the claims hereof, the present clutch construction comprises a housing 10 which contains a first power train section having drive hub means 12 rotatably mounted on a rotation axis 14 in said housing and having bushing means 16 adapted for connection to an output or drive shaft 18 of an engine for rotation thereby, centrifugal cam means 20 mounted on a distal portion 22 of said hub means for rotation therewith, pressure plate means 24 mounted on said cam means for rotation therewith and for axial motion with respect thereto in response to changes in engine speed, said hub means 12 further having axially extending first keying means 26 extending distal 25-to-proximal 27, backing plate means 28 affixed to said hub means proximal to said first keying means and axially spaced from said pressure plate means to provide a substantially closed containment c 30 for a clutch disc gallery at least two annular floater discs 32 having second keying means 33 axially keyed to and slidable along said first keying means 26 between said backing plate means and said pressure plate means for rotation therewith and for axial movement thereon within said housing, each said floater disc having a substantially uniform axial thickness with proximal 34 and distal 36 annular smooth metal contact faces, a second power train section in said housing and having one or more fiction discs 38 mounted over and radially spaced from said first keying means and axially positioned between said floater discs and keyed to said housing 10 as at recesses 40 interiorly of sprocket drum 56 by modes 41 on 38 for axial movement in said housing and for rotation therewith, each said friction disc having an annular metal support 42 of substantially uniform axial thickness providing an annular rim 44 having said nodes 41, a plurality of composition friction segments 46 affixed to each side of said rim and angularly spaced there around by oil discharge slot means 48 to provide a friction face 49, albeit discontinuous, on each side of said rim, said cam means 20 being adapted to axially force said pressure plate means against a clutch gallery of floater discs and friction disc to force said floater discs and friction discs into locking engagement with each other at a predesigned engine speed whereby said housing will be forced to rotate thus its engagement with the rotating friction discs, and power transmission means 50 affixed axially to the exterior of said housing for connection to one or more wheels of a vehicle for driving the same, wherein said oil discharge slots 50 extend from an outer periphery 52 of said friction face thru an inner periphery 54 thereof, wherein said metal faces and said friction faces are in general axial alignment, and wherein the ratio of the total contact surface area (in.²) of a friction face to the total volume (in.³) of the slots in said friction face ranges from about 60 in.²/in.³ to about 100 in.²/in.³.

It is particularly noted that a test was conducted under actual running conditions employing a test clutch identical to the presently claimed clutch except that the total volume of the test clutch slots measured approximately 0.01 in.³ per side of the friction disc and the floater discs and backing plate were not apertured as claimed by applicant. In the test, the total volume of the slots per side of the presently claimed friction disc measured approximately 0.036 in.³.

In the test, the temperature within the disc gallery of the test clutch rose to about 280° F., whereas within the disc gallery of the present clutch the temperature did not get above about 200° F.

The test confirmed that the rpm of clutch engagement or disc lock-up for the test clutch changed up and down from about 25-30% at 9800 rpm after only two or three laps of a quarter mile course, whereas no noticeable change from 9800 rpm lock-up for the present clutch occurred for many times that distance. Actual replacement of the test floater and friction discs was needed at 420′ laps, whereas replacement of the present discs was made, but riot actually needed at 2500 laps.

Referring farther to the drawings, Me clutch housing 10 typically consists of a sprocket drum 56 and an oil cover 58, the outer peripheral rims of which are bolted together as at 60 and sealed by an annular gasket 62. The motor output shaft 18 is provided with a Woodruff Key 64 which keys into keyway 66 in bushing means 16. An Allen socket sleeve nut 68 threads onto the threaded end 70 of shaft 18 and tightens against annular shoulder 72 of bushing means 16 to lock bushing 16 and disc drive gear 74 of the drive hub means in proper axial position on shaft 18. The clutch drive hub means, pressure and backing plate means and discs are axially retained in position by sliding abutment of the distal end 76 of bushing 16 with annular surface 78 of the oil cover, and with sliding abutment of the proximal bearing surfaces 79 of protrusions 80 on backing plate 28 with the inner surface 82 of sprocket drum 56. Backing plate 28 is affixed to the drive gear 74 with a plurality of machine screws 84, and the support body 85 of cam means 20 is affixed to 74 also by a plurality of machine screws 86.

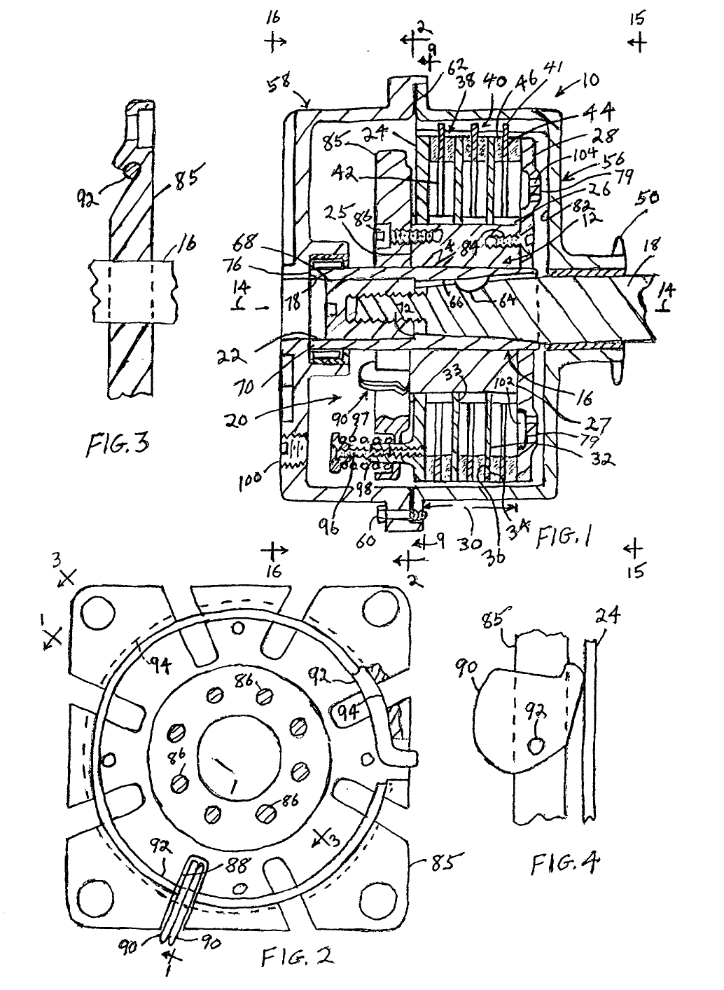

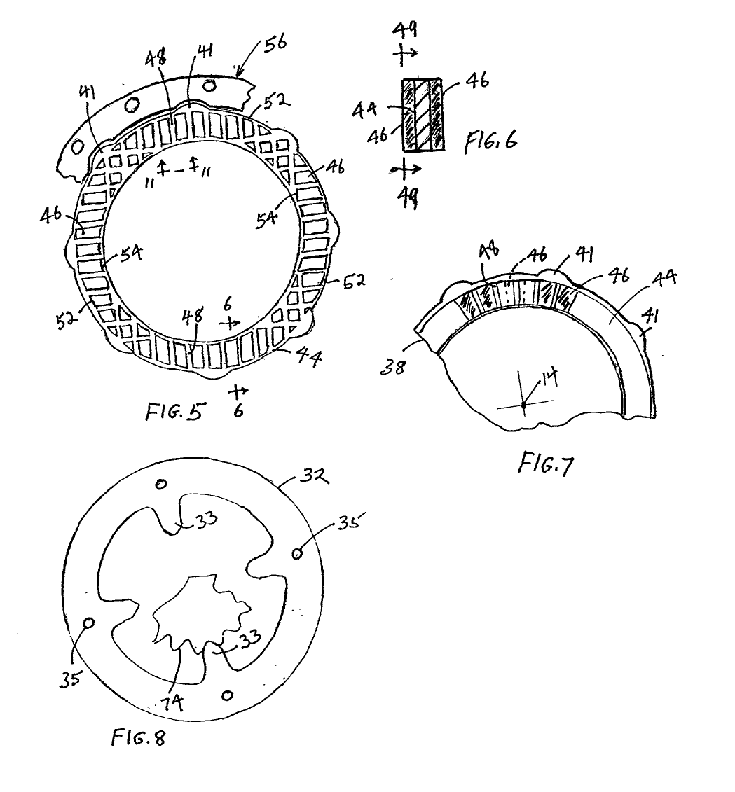

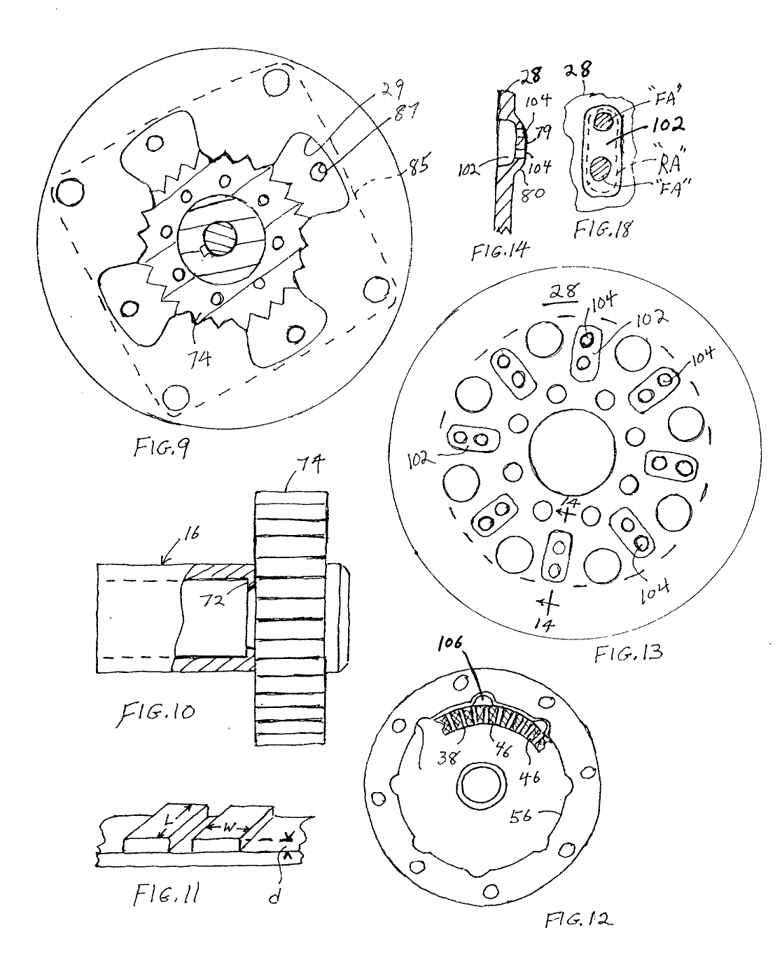

Referring particularly to FIGS. 1-4, the centrifugal cam means 20 in the embodiment shown comprises support body 85 having a plurality of recesses 88 substantially equally angularly spaced around its periphery for pivotally accommodating pairs of cam weights 90. These weights are pivotally mounted on a spring metal ring axle 92 sprung into annular groove 94 in body 85. Upon rapid rotation of motor shaft 18, weights 90 as shown in FIG. 4 are rotated around axle 92 to force pressure plate 24 in a proximal direction as viewed in FIG. 1 to effect the clutch engagement or lock-up phase, wherein the more rapid engine acceleration the faster the rate of clutch lock-up.

In regard to the cam means and pressure plate a plurality of oil escape apertures 87 are provided thru body 85 to assist in oil removal from the disc gallery 30 thru openings 29 in the pressure plate.

With further reference to FIG. 8 a plurality of apertures 35 are provided thru the floater discs at said metal faces thereof such as to fluid communicate with at least one adjacent friction disc whereby as the rotating floater disc is closing on but still sliding by the friction disc during engine acceleration but before disc lock-up, oil which is trapped on said metal face of said floater disc will be compressed by the action of the cam means and forced thru said apertures and into rapidly passing slots of said adjacent friction disc. It is preferred that the total flow area of the said apertures thru each floater disc equals from about 0.25 to about 2.0% of one metal face area of the disc.

Referring to FIG. 17 the adjustment of the resistance to axial motion of the pressure plate 24 is made by tightening or loosening the resistance adjustment Allen head screw 96 against the force of compression spring 97 in the threaded stud 98 which is integral with pressure plate 24. Tightening of the screw increases the rpm necessary to produce clutch lock-up. As shown in FIG. 2, four of these adjustment mechanisms are provided in the embodiment shown. It is noted that where the present invention is utilized, adjustment of the clutch engagement rpm by means of the above adjustment mechanism is made easier since the aforesaid variations of 25% to 30% in required engine speed is essentially eliminated. The screw adjustments are made by removal of threaded plugs 100 and insertion of an Allen wrench into the screw head.

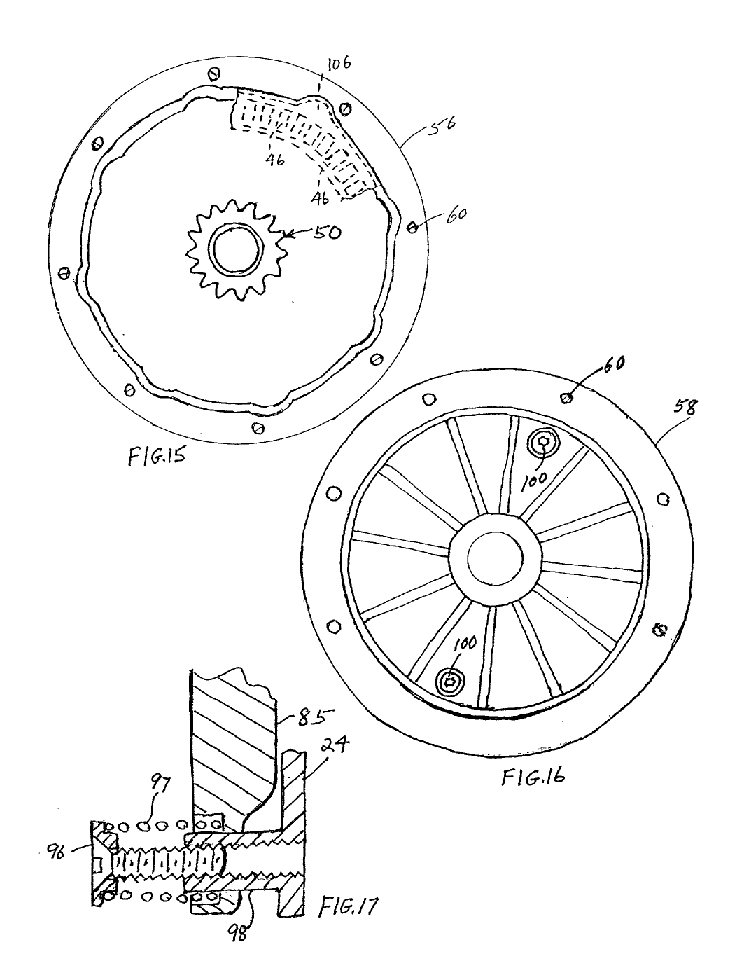

Referring to FIGS. 1, 13 and 14, the backing plate is indented as at 102 to provide bearing surfaces 79, which indentations tend to trap oil which is then slung radially outwardly at high rpms to cause lock-up hydraulic resistance at the segment faces. In accordance with one aspect of the present invention, apertures or ports 104 are formed thru the plate to prevent trapping of oil in the indentations. The total flow areas “FA” of these apertures shown cross-hatched in FIG. 18, for each indentation is preferably from about 20% to about 60% of the recess area “RA” shown outlined in FIG. 18.

Referring to FIG. 7, the friction segments 46 are slightly wedge shaped such as to be oriented radially from rotation axis 14. It is preferred that in all embodiments of segments 46 herein, the segments on opposite sides of rim 44 be angularly offset as shown by the dotted lines in FIG. 7.

This invention has been described in detail with particular reference to preferred embodiments thereof, but it will be understood that variations and modifications will be effected within the spirit and scope of the invention.

I claim:

1. An oil bath clutch construction comprising for an oil filled disc clutch comprising a housing which contains a first power train section having drive hub means rotatably mounted on a rotation axis in said housing and having bushing means adapted for connection to an output or drive shaft of an engine for rotation thereby, centrifugal cam means mounted on a distal portion of said hub means for rotation therewith, pressure plate means mounted on said cam means for rotation therewith and for axial motion with respect thereto in response to changes in engine speed, said hub means further having axially extending first keying means extending distal-to-proximal, backing plate means having radially outer rim means providing an annular contact surface, said backing plate means being affixed to said hub means proximal to said first keying means and axially spaced from said pressure plate means to provide a substantially closed containment cavity for a clutch disc gallery, at least two annular floater discs having second keying means axially keyed to and slidable along said first keying means between said backing plate means and said pressure plate means for rotation therewith and for axial movement thereon within said housing, each said floater disc having a substantially uniform axial thickness with proximal and distal annular smooth metal contact faces, a second power train section in said housing and having one or more friction discs mounted over and radially spaced from said first keying means and axially positioned between said floater discs and keyed to said housing as at location for axial movement therein and for rotation therewith, each said friction disc having an annular metal support of substantially uniform axial thickness providing an annular rim a plurality of composition friction segments affixed to each side of said rim and angularly spaced there around by oil discharge slot means to provide a friction face albeit discontinuance, on each side of said rim, said cam means being adapted to axially force said pressure plate means against a clutch gallery of floater discs and friction disc pack to force said floater discs and friction discs into locking engagement with each other at a predesigned engine speed whereby said housing will be forced to rotate thru its engagement with the rotating friction discs, and power transmission means affixed axially to the exterior of said housing for connection to one or more wheels of a vehicle for driving the same, wherein said oil discharge slots extend from an outer periphery of said friction face thru an inner periphery thereof, wherein said metal faces and said friction faces are in general axial alignment, and wherein the ratio of the total contact surface area (in²) of a friction face to the total volume (in.³) of the slots in said friction face ranges from about 60 in.²/in.³ to about 100 in.²/in.³.

2. The clutch construction of claim 1 wherein a plurality of apertures are provided thru at least one said floater disc at said metal faces thereof such as to fluid communicate with at least one adjacent friction disc whereby as the rotating floater disc is closing on but still sliding by the friction disc during engine acceleration but before disc lock-up, oil which is trapped on said metal face of said floater disc will be compressed by the action of the cam means and forced thru said apertures and into rapidly passing slots of said adjacent friction disc.

3. The clutch construction of claim 2 wherein the total flow area of the said apertures thru each floater disc equals from about 0.25 to about 2.0% of one metal face area of the disc.

4. The clutch construction of claim 3 wherein the said apertures are substantially of the same flow area are substantially uniformly angularly spaced around the metal face.

5. The clutch construction of claim wherein the oil discharge slots of the friction discs completely divide said composition segments from each other.

6. The clutch construction of claim 1 wherein said pressure plate means and said centrifugal cam means are provided with cooperating oil passage means for allowing oil pressurized within the clutch disc gallery to flow into the distal end of the clutch housing.

7. The clutch construction of claim 1 wherein the distal side of said backing plate means is formed to provide a plurality of bearing surface forming recesses lying radially inwardly of said contact surface of said backing plate means, and aperture means formed thru said backing plate means in said recesses to allow oil therein to flow directly into the proximal portion of said clutch housing.
